(19) United States
(12) Patent Application Publication
(10) Pub. No.: US 2016/0116910 A1
(43) Pub. Date: Apr. 28, 2016

(54) Method and Process Automation System With a Central Computing Unit

(71) Applicant: SIEMENS AKTIENGESELLSCHAFT, Muenchen (DE)

(72) Inventors: Benjamin LUTZ, Pfinztal (DE); Stefan RUNDE, Walzbachtal (DE); Andreas SCHOLZ, Unterschleissheim (DE)

(21) Appl. No.: 14/895,382

(22) PCT Filed: May 22, 2014
(86) PCT No.: PCT/EP2014/060543

§ 371 Date: Dec. 2, 2015

(30) Foreign Application Priority Data
Jun. 3, 2013 (EP) 13170252.4

(51) Int. Cl. G05B 19/418

(52) U.S. Cl. CPC G05B 19/4185; G05B 2219/31161; G05B 2219/31457

(57) ABSTRACT

A method for operating a process automation system that is configured to control an industrial process and/or traffic-control signals, wherein the process automation system includes field devices arranged in a field of the industrial process and a central controller unit for controlling the process through the field devices, where the central controller unit generates control data for the field devices by running a control program, where the control program forms a browser executable application that receives and processes field data from the field devices and generates and sends out the control data, and where the central controller unit executes an internet browser program and the internet browser program runs the application.

### CROSS-REFERENCE TO RELATED APPLICATIONS

This is a U.S. national stage of application No. PCT/EP2014/060543 filed 22 May 2014. Priority is claimed on European Application No. 13170252.4 filed 3 Jun. 2013, the content of which is incorporated herein by reference in its entirety.

### BACKGROUND OF THE INVENTION

1. Field of the Invention

The invention relates to a method and process automation system comprising field devices, such as sensors, which are arranged in a field of the process, e.g., next to machines in a factory building, where the field devices are connected to a central controller unit for controlling the process through the field devices.

The process automation system may be used to automatically control an industrial process, such as the processing of chemicals or other substances or product and/or the production of products or goods. In the context of the invention, a process automation system may also be used for controlling traffic-control signals.

2. Description of the Related Art

A conventional process automation system may comprise sensors for obtaining measurement data describing the current state of components of the process, such as the speed of a belt conveyor, the flow of a fluid through a valve, the activity of a pump or the torque generated by an electrical engine. The sensors may be coupled to a central controlling unit by a communication network structure that may comprise a field bus, such as a Profinet-Bus, or an Ethernet-network. Here, the measurement data and the data describing the current state of a field device are denoted as field data. The central control unit may receive the field data from the field devices and process the field data to provide a monitoring functionality for observing the process in a control room. Also, with the central control unit, control data may also be generated for configuring the field devices, such as setting a new parameter value in a control algorithm of one of the field devices. This type of control data, i.e., the configuration data, may be set by an engineer who monitors the process automation system in a control room.

If the data bandwidth of the network structure is large enough or if the process involves comparatively slow changes, such as the filling of a large basin with water using a small pump, the central control unit may also provide control loops that process the field data to generate control data for controlling the behavior of the field devices, such as stopping the pump, when the amount of water in the basin has reached a given level.

The described functionalities are generally provided by a control program that is run by the central controller unit. To provide a central controller unit with its functionalities, the control program must be written in a program code that is suitable for being run by the central controller unit. If a new system is to be developed that shall, e.g., use a new generation of computing devices, this may imply that the program code of the control program must be re-written or otherwise it may not be possible to run the old control program on the new computer devices. This interdependence of the control program and the computing devices of the central controller unit makes the development of a process automation system costly.

### SUMMARY OF THE INVENTION

It is therefore an object of the present invention to provide a process automation system that allows the exchange of hardware components of the central controller unit without having to adapt the control program.

This and other objects and advantages are achieved in accordance with the invention by a method, process automation system, storage medium and web server device, in which the process automation system comprises field devices arranged in a field of the process and the central controller unit controls the process through the field devices. In accordance with the method of the invention, one or several or all of the field devices transmit field data, such as measurement data, to the central controller unit and the central controller unit generates control data for one or several or all of the field devices by running a control program. The control data may be for re-configuring the respective field device and/or for directly controlling the process through the field device. The exchange of data may occur through a communication network structure.

In accordance with the invention, a browser executable application is provided as the control program. This application is designed to receive and process the field data and to generate and send out the control data. Instead of executing a dedicated control program written in binary code for its hardware components, the central controller unit is now executing an Internet browser program which, in turn, is running the application.

Accordingly, the process automation system in accordance with the invention comprises the field devices, the central controller unit and a communication network structure coupling the field devices with the central controller unit. In accordance with the invention, the central controller unit now comprises at least one computing device with an Internet browser program, where the computing device is configured to execute at least one instance of the Internet browser program. In other words, each computing device may at the same time execute the browser program once or, e.g., based on a multitasking operation system, even more than only once.

The process automation system in accordance with the invention also comprises a storage unit, such as a web server, that may be contacted by each Internet browser program. The storage unit is configured to provide an application to each executed Internet browser program for running the application. This application is again the already mentioned special application that makes the control program, i.e., when the application is run by an Internet browser program, the application receives field data from the field of the process over the network structure and processes the received field data and generates and sends out control data to the field over the network structure.

The invention provides the advantage that in the central control unit the control program does not have to be changed even if the underlying system for running the control program is exchanged, may it be that a new operating system is used or the computer chips, such as graphic cards, are changed. The control program is provided as a browser executable application and may thus be run by any browser program that is suitable for interpreting the script language in which the application is written. When developing a new process automation system, after designing the central controller unit, the developers may simply obtain an Internet browser program like it which is readily available for most standard computing devices. This Internet browser program may than run the old application.

As a consequence, it is even possible to use a mixed hardware structure for providing the computing devices in a central computing unit. In particular, as the at least one computing device, the central control unit may comprise one or more of each of the following hardware units: a personal computer, a notebook, a tablet-computer or a smartphone. Computing devices of this type generally already comprise an Internet browser program.

A suitable form in which the application may be provided is given, if the program code is written in a script language, such as HTML5 and/or JavaScript.

In one embodiment, the browser executable application comprises at least one control loop for controlling at least a part of the process. In other words, at least one control loop for controlling the process runs through the Internet browser program. Each control loop is designed to generate at least a part of the control data, dependent on at least a part of the received field data. The application may provide, e.g., a setpoint control loop for adapting a physical quantity, such as pressure or speed, to a given setpoint. A control loop may comprise a proportional, integral and/or derivative control. A control loop may also perform logic and/or sequential control. It may also comprise a neural network and/or fuzzy logic. Providing the at least one control loop in the application has the advantage that in the field itself less dedicated hardware, such as a programmable logic controller (PLC), is needed, which makes the system cheaper with regard to production.

In another embodiment, the browser executable application is configured to provide a user interface to a user of the browser program. The user interface may provide a monitoring functionality for the process automation system, i.e., a part or all of the received field data may be displayed or a quantity derived from the field data.

Alternatively or additionally, the interface may provide a configuration functionality for setting a parameter value of at least one parameter of the control unit itself and/or a parameter value of one or more of the field devices. This provides the advantage that the central control unit may be used as an interface for the process automation system as it is needed in a control room. Thus, even a whole supervisory control and data acquisition (SCADA-system) may be transferred to new computing devices without having to adapt the corresponding program code of the SCADA-system.

Further, the application may also be configured to provide the functionality of an engineering tool for setting up the process automation system. Such an engineering tool may, for example, provide a part or all of the functionalities know from a conventional engineering tool like the product WTIA” (Totally Integrated Automation) provided by the company Siemens A.G.

In accordance with one embodiment, the central control unit executes more than one Internet browser program, i.e., at least one additional Internet browser, where each additional Internet browser is also running the same application. In other words, several applications of the same type are running in parallel, i.e., at the same time. This results in the generation of equivalent control data.

However, this does not imply that these control data are necessarily identical. If, for example, one of the computing devices is malfunctioning, such as, due to heat, this may now be detected. Further, a computer device for the computing unit may be, for example, a laptop. The user of this laptop might decide to disconnect the laptop to take it with him/her. Including several computing devices as part of the central control unit thus provides the advantage that defective or otherwise unavailable computing units do not have an effect on the control data needed for controlling the process. As control data is now generated in a redundant manner, the contemplated embodiment preferably also comprises a verification unit, which receives the control data sent out by all the running application and selects the control data of one of them in accordance with a pre-defined selection criterion.

In accordance with another embodiment, this selection criterion comprises the condition which, in the case that only two applications are running, the application running for the longest time is declared as a master and the control data of the master is selected. Alternatively or additionally, in the case that more than two applications are running, the control data of all the applications are compared and the control data are selected in accordance with a majority vote. This allows the detection of malfunctioning computing device, which is then preferably disconnected from the central computing unit or otherwise tagged as suspicious.

As the application may also receive user input, one embodiment of the application deals with the event that one of the running applications receives a user input regarding a re-configuration of the application, which none of the other running applications is aware of. In this case, the application notifies the remaining running applications of this re-configuration. The remaining running applications may then re-configure themselves in accordance with the user input. In other words, all the running applications are synchronized, even if the user only re-configures one of them.

In the context of the disclosed embodiments of the invention, the field data transmitted from the field devices to the central control unit may comprise measurement data of physical quantities, where the measurement data are correlated to the current state of the process. The field data may also describe a state of at least one of the field devices, i.e., for example, the field data may also comprise a current value of an algorithm-parameter or a mode identity value describing the mode in which a field device is currently running. For example, a field device may report that it has now entered a stand-by mode.

Accordingly, a field device may be an “input device” designed for transforming a sensor signal into network data that may be transferred via the network structure. An example of such an input device is the product “ET200M” offered by the company Siemens AG. Another example of a field device is a sensor device. In particular, the data may be provided by a sensor device that is directly connected to the network structure, i.e., the sensor device comprises the means for transforming the measurement value into field data that are suitable for transmittal over the network structure. Another type of field device that may be comprised in the inventive system is an actuation device directly connected to the network structure. Such an actuation device can be, for example, a pump, a valve or an electrical machine. For directly connecting the actuation device to the network structure, it comprises means for receiving control data from the network and processing the received control data to interpret the control commands comprised in the control data. However, for actuation devices that are unsuitable for being directly connected to the network structure, a field device may also be provided, which is an so-called “output device”. Such an output device is configured to transform the control data into a control signal for such an actuation device.

Accordingly, at least part of the control data may comprise a control command for a field device and/or a setpoint value for a setpoint control performed by a field device.

In the above description of the process automation system in accordance with the disclosed embodiments, it is mentioned that the application is provided to the Internet browser programs for running the application. As Internet browser programs are generally designed to obtain their data from a web server, one embodiment of the invention comprises a special web server. The web server is configured to provide the application to requesting Internet browser programs.

Additionally, the web server couples the field devices and the computing unit, i.e., the web server is configured to receive a part or all of the field data and to forward at least part of the received field data to all running applications in the computing unit. This provides the advantage that the running applications do not have to be supplied with information on how to address each field device. Likewise, the applications may send their control data to the web server, which then distributes the control data to the right field devices.

As previously mentioned, providing a control loop in an application requires a certain minimum data bandwidth to provide these control data in time. In the case that parts of the field devices require faster control loops, the system may also comprise at least one real-time control device that is configured to generate additional control data. Such a real-time control device may be, for example, a programmable logic controller. The real-time control device may itself be a field device reporting, for example, status data to the central control unit and receiving control data concerning, e.g., setpoint values.

As the central element of the invention is a browser executable application, the invention also comprises a tangible storage medium, on which a control program in the form of a browser executable application is stored. This application is configured such that, if run by an Internet browser program, it receives and processes field data from field devices of a process automation system and generates and sends out the control data to field devices of the system.

The inventive application may also comprise further features that have already been described in the context of the inventive method and the inventive system.

It is also an object of the invention to provide a web server device. The web server device is the one already described, i.e., the web server device provides the application to the central control unit such that the central control unit may run the application via one or several Internet browser programs. In other words, the web server device may connect on one side to a field bus and on the other side to a standard computer network, for example an Ethernet network. The web server may then be used to transfer field data out of the field and into the computer network to provide the field data to the running applications. The inventive web server device also comprises the already described tangible storage medium that stores the application.

The inventive web server device provides the advantage that an already existing process automation system with field devices arranged in a field of the process and a central controller unit comprising one or several computing devices, such as, personal computers or workstation computers, may be transformed into an embodiment of the inventive automation system. By installing the web server device into the existing system, the computing devices of the central control unit only need to execute one or several Internet browser programs. The Internet browser programs will then request the application from the web server and run one application each. This will result in the processing of the field data and the generation of control data as described.

For connecting the inventive web server device to the already existing system, the inventive web server device comprises a first connecting unit for connecting the device to a first part of a communication network structure, where the first connecting unit is configured to receive field data from field devices over the first part of the communication network. The web server device also comprises a second connecting unit for connecting the device to a second part of a communication structure, where the second connecting unit is configured to forward at least part of the received field data to at least one Internet browser program over the second part of the communication network structure.

In order to enable an Internet browser program to obtain the application over the second part of the network, the web server device also comprises a web server program for sending out the application to at least one requesting Internet browser program. Such a web server program may be a standard web server.

The web server device may also comprise further features as they have already been described in the context of the inventive method and the inventive automation system.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the following, the invention is described in more detail on the basis of an example in which:

FIG. 1 shows a schematic presentation of an embodiment of the inventive process automation system; and

FIG. 2 is a flowchart of the method in accordance with the invention.

### DETAILED DESCRIPTION OF THE EXEMPLARY EMBODIMENTS

The features of the process automation system that are described in the following are to be considered as independent from each other and as describing each a separate advantageous embodiment of the invention that provides a separate advantage and that may be combined with other features in a different way from that shown in the figure. Further, the example may also be supplemented by features as they have already been described.

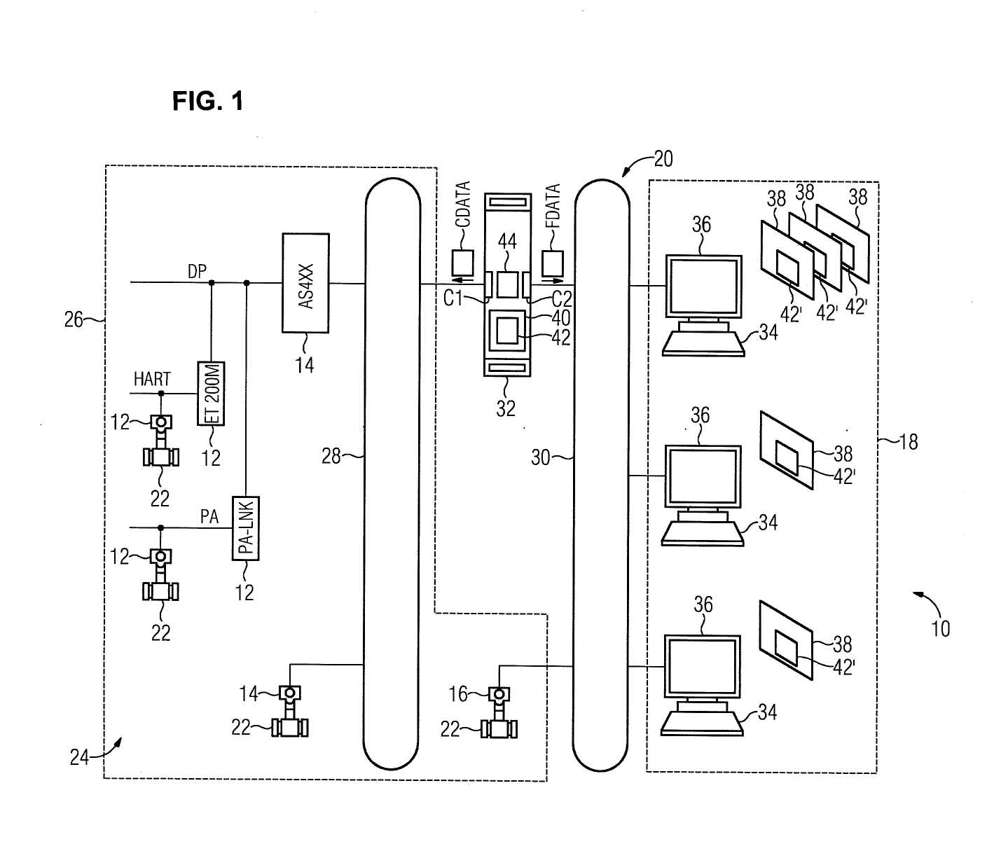

FIG. 1 shows a process automation system 10 comprising three groups of components, i.e., field devices 12, 14, 16, a central control unit 18 and a communication network structure or short network 20. Each field device 12, 14, 16 may be coupled to a process-component 22, which is part of a plant 24, such as a power plant or a production plant, or an oil refining plant of a system of traffic-control lights in a town. The field devices 12, 14, 16 may be distributed over an area which forms the field 26, in which the process of the plant 24 is performed. The field may comprise, e.g., a single room, a building, several buildings or a town.

The network structure 20 connects the field devices 12, 14, 16, i.e., field 24, to the central computing unit 18. The network structure 20 may comprise a plant bus 28, which may be realized as an industrial Ethernet. For the central controller unit 18, the network 20 may comprise a terminal bus 30, which may also be realized in Industrial-Ethernet technology. In the example shown, the plant bus 28 and the terminal bus 30 may be interconnected by a server 32. The server 32 is a web server device in accordance with the invention. The server 32 is connected to the plant bus 28 via a first connecting unit CI and to the terminal bus 30 via a second connecting unit C2.

A field device 14 may be directly connected to the plant bus 28 or a field device 16 may also be directly connected to the terminal bus 30. One of the field devices 14 may be an input device, such as the product SIMATIC S7-400 offered by the company Siemens AG. A field device 12 may be connected to the plant bus 28 indirectly via the input device. For the connection to the input device 14, the field device 12 may exchange data with the input device 14 over a field bus DP, PA, highway addressable remote transducer protocol (HART), DP, PA may be, e.g., a Profibus derivative. The field bus HART may be based on HART technology. The field buses may be linked by a further field device 12 such as a PA-link (PA-LNK) or, for example, another input device 12 like the product ET200M offered by the company Siemens AG.

The central controller unit 18 may comprise one or more computing devices 34, each of which may be, for example, a workstation, a personal computer, a notebook, a tablet-computer or a smartphone. One or several of the computing devices 34 may also be configured as a terminal with a monitor 36. The central controller unit 18 may then be installed in a control room for the plant 24.

Each computing device 34 may execute one or more instances 38 of an Internet browser program. Each instance 38 may contact the server 32. The server 32 comprises a storage medium 40, e.g., a hard drive or a CD-ROM, on which an application 42 is stored. The application 42 is written in program code that is executable or interpretable or runnable by each of the Internet browser program instances 38. The server 32 may provide the application 42 to each of the instances 38.

The increasing performance of web browsers and the corresponding servers has rendered it possible to use the browser as a performance platform for applications and to produce an alternative for the hitherto common applications for operating systems, such as Windows or Linux.

The advantage of browser-based solutions is that on the user's side merely a browser 38 is required. The installation and maintenance of concrete applications 42 can occur centrally, and for all applicants, simultaneously on the server 32. The application 42 is a novel control system software for an automation system based on such a solution. The control system software fulfils the classic control and monitoring tasks, however offers the following specific characteristics:
lean solution for small and medium-sized facilities, which can do without the classic pyramid structure of a PLS;
flexible, scalable solution for control systems;
zero installation of the control system software;
setup with standardized IT hardware possible (router, notebook or PC); or
proprietary solutions;

Classic control system hierarchies do not address this problem.

The software application 42 may be realized by modern web technologies. The reason for this is that modern browsers and web-oriented languages (HTML5, JavaScript, and other Scripting Languages, or Java), due to their performance and flexibility, offer more advantages than classic applications (programs installed on a PC). Software applications applied to web technologies can be used directly by a browser without local installation and also are largely independent of the hardware, on which the browser is running. Even 3D games with complex graphics and animations, which require a large amount of computing power, can be realized via web technologies and can be played in standard browsers. The processing of several thousand inquiries per second made by a browser to a web server do not represent a problem.

Large parts of a known control system (serving and observing, or controlling and regulating) are realized by software programs classically installed on computers and controls and also run there. One possibility of raised availability in this context is the provision of several computers, on which the same software program is installed.

The system 10 shown in FIG. 1 is based on the idea to use the advantages of modern web technologies, in order to render particularly small and medium-sized control systems more scalable, more flexible, and at the same time more cost-efficient, without having to make concessions with regard to availability. Moreover, thereby also modern devices, such as for entity tablet PCs can be employed in the field of control system technology.

Whilst the architecture of a control system shown in FIG. 1, the architecture, at first glance, is similar to a classic automation pyramid, however, differs drastically in FIG. 1 of control system technical tasks to the individual to the individual components.

At the core of the control system 10 shown is a server 32, which is responsible for the connection with the field 26. All I/O-data (I/O—Input/Output) or I/O-signals of the field devices and the controls, that is the field data FDATA coming from and the control data CDATA going to the field 26, are accessible by way of reading or writing. Moreover, a web server runs on the server 32, via which web applications like the application 42 are provided. These web apps represent the actual core of the invention disclosure, since these (besides the classic control system functions in the sense of an operation and observation) also take over regulation and control of technical tasks. This means that in contrast to classic approaches of automation system, functionality, especially control loops, is shifted into the web application, and in this course are processed by a browser.

The control represented in FIG. 1 essentially has the following tasks:
connection classic field devices via profibus DP/PA, Hart, etc. and exchange of the EA signals of the field with the server;
processing “real-time critical” control and regulation tasks that can only be insufficiently fulfilled by a browser

Modern field devices 14, 16 with ethernet interface may also be directly connected with the server, as shown in FIG. 1.

As has already been set out, control system technical tasks, such as operating and observing, as well as control and regulation technical algorithms, are realized by web applications. Each computer 34 (e.g., PC, notebook, tablet, smartphone) connecting to the web server of the server 32 loads the web application 42 into a browser 38 and starts the processing. The requirements with regard to scalability, flexibility, and zero installation of a control system software are completely fulfilled by the approach of a control system running in the browser 38. Moreover, aspects of raised availability can also be addressed to a large extent, when using multi-instance/multi-entity capability of web apps and browsers.

A method for fulfilling raised availability and redundancy is explained in the following:
each browser entity loading the web application from the server from then on is provided with all the I/O signals of the field plane;
each operation or input into an entity of the control system web application is synchronized on all logged on entities. Thereby each entity of the control system we application is in the same condition.
The outputs of the control and regulation technical functions CDATA of all control system web applications 42′ for the field plane 26 are transferred into the server 32. If fewer than three instances 42′ of the control system web applications are logged on, then the output of the instance 42′ with the lowest identification number is transferred to the field 26, as long as it confirms its presence by regular signals. If three or more instances 42′ are logged on, then the server 32 forwards the outputs of the instances in accordance with the majority principle. Those web application entities 42′ that differ from the majority are separated.

In a further embodiment, the control system web application 42 also communicates directly with devices 16 of the field plane 26. This scenario is advantageous in cases, in which all field devices are connected directly by Ethernet, because then the central server can be done without. For realizing this, the Internet browser program may be required to offer access to the I/O values from the facility (in a similar way as currently present browser developments already allow for access to the hardware, such as the 3D graphic card).

In a further embodiment, in addition to implementation of the control system, the engineering of the control system including a—Human Machine Interface (EMI) is also effected via a browser-based solution. The advantages (similarly to the control system) consist in the reduced administrative complexity and the enhanced scalability, because a nearly random number of instances/entities of the engineering application can be started. By the central access point in the server it can moreover be ensured that all engineers work at the current state of the system and changes can be synchronized and coordinated.

The dedicated system (hardware and software) used today for implementing the control system is used by a browser-based infrastructure. The new architecture allows for a simple scalability (control system can be performed in parallel on several devices) and a broader hardware support (the browser is supported as a platform by a broad basis of devices in contrast to the conventional customized hardware).

From the viewpoint of the architecture, a further fundamental difference consists in that the system, which performs the control system (the computer with browser), is separate from the system storing and administrating the control system software.

As a result, the costs for the entire system can be reduced, because it is possible to also use low-cost PC hardware and not all functions need to be performed by expensive (specialized) server hardware.

In sum, the example illustrates how the invention offers a distributed control system (DCS) based on web-technology.

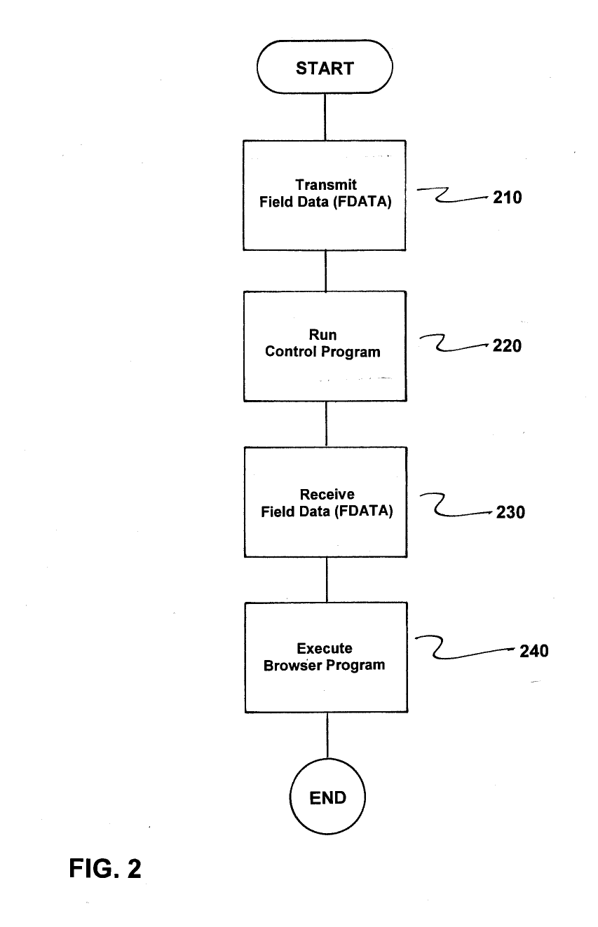

FIG. 2 is a flowchart of a method for operating a process automation system (10) which controls at least one of (i) an industrial process and (ii) traffic-control signals, where the system (10) comprises field devices (12, 14, 16) arranged in a field (26) of the industrial process and a central controller unit (18) for controlling the industrial process through the field devices (12, 14, 16).

The method comprises transmitting, by at least one of the field devices (12, 14, 16), field data (FDATA) to the central controller unit (18), as indicated in step 210.

Next, a control program (42′) comprising a browser executable application (42) is run by the central controller unit (18) to generate control data (CDATA) for the at least one field device (12, 14, 16), as indicated in step 220.

Next, the field data (FDATA) is received at the browser executable application (42) and processed by the browser executable application (42) to generate and send out the control data (CDATA), as indicated in step 230.

An internet browser program (38) is now executed by the central controller unit (18), where the Internet browser program (38) runs the application (42), as indicated in step 240.

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. A method for operating a process automation system which controls at least one of (i) an industrial process and (ii) traffic-control signals, the system comprising field devices arranged in a field of the industrial process and a central controller unit for controlling the industrial process through the field devices, the method comprising:
transmitting, by at least one of the field devices, field data to the central controller unit;
running, by the central controller unit, a control program comprising a browser executable application to generate control data for the at least one field device;
receiving the field data at the browser executable application and processing the field data by the browser executable application to generate and send out the control data;
executing, by the central controller unit, an internet browser program, the internet browser program running the application.

17. The method according to claim 16, wherein the application comprises at least one control loop for controlling at least a part of the industrial process; and wherein each control loop generates at least a part of the control data dependent on at least a part of the received field data.

18. The method according to claim 16, wherein the application is provides a user interface to a user of the browser program, the user interface providing a monitoring functionality for at least one of (i) the process automation system and (ii) a configuration functionality for setting a parameter value of at least one of (i) at least one parameter of the central controller unit and (ii) at least one of the field devices.

19. The method according to claim 16, wherein the application comprises an engineering tool for setting up the system.

20. The method according to claim 16, wherein the central controller unit executes at least one additional internet browser program, each additional internet browser program also running the same application; and wherein a verification unit receives the control data sent out by running applications and selects the control data of one of the running applications in accordance with a pre-defined selection criterion.

21. The method according to claim 20, wherein the selection criterion comprises at least one of:
(i) the application running for the longest time is declared a master and the control data of the master is selected when only two applications are running; and
(ii) the control data of all applications are compared and the control data are selected according to a majority vote when more than two applications are running.

22. The method according to claim 20, wherein one of the running applications receives a user input regarding a re-configuration of the running application and the one running application notifies remaining running applications of this re-configuration.

23. The method according to claim 20, wherein one of the running applications receives a user input regarding a re-configuration of the running application and the one running application notifies remaining running applications of this re-configuration.

24. The method according to claim 16, further comprising:
reporting at least one of (i) at least a part of the field data a measurement and (ii) a state of at least one of the field devices.

25. The method according to claim 16, wherein at least a part of the control data comprises at least one of (i) a control command for a field device and (ii) a setpoint value for a setpoint control performed by a field device.

26. A process automation system configured to control at least one of an industrial process and traffic-control signals, the system comprising:
field devices arranged in a field of the industrial process;
a central controller unit for controlling the industrial process through the field devices by running a control program, the central controller unit comprising at least one computing device including an internet browser program which executes at least one instance of the internet browser program;
a communication network structure coupling the field devices with the central controller unit; and
a storage unit containing the control program as a browser executable application which receives field data from the field over the communication network structure, processes the received field data and generates and sends out control data to the field over the communication network structure, the storage unit being configured to provide the application to each executed internet browser program for running the application.

27. The system according to claim 26, wherein the field devices comprise at least one of:
(i) at least one input device for transforming a sensor signal into network data;
(ii) at least one sensor device directly connected to the network structure;
(iii) at least one actuation device directly connected to the network structure; and
(iv) at least one output device for transforming the control data into a control signal for an actuation device.

28. The system according to claim 26, wherein the field devices and the central controller unit are coupled through a web server which receives a part or all of the field data and forwards at least a part of the received data to all running applications in the central computing unit.

29. The system according to claim 27, wherein the field devices and the central controller unit are coupled through a web server which receives a part or all of the field data and forwards at least a part of the received data to all running applications in the central computing unit.

30. The system according to claim 26, wherein at least one real-time control device is provided generates additional control data.

31. A non-statutory tangible storage medium including a control program comprising a browser executable application which, when executed by an internet browser program, receives and processes field data from field devices of a process automation system and generates and sends out control data to field devices of the system.

32. A web server device comprising:
a first connecting unit for connecting the web server device to a first part of a communication network structure, the first connecting unit receiving field data from field devices over the first part of the communication network structure;
a second connecting unit for connecting the web server device to a second part of a communication network structure, the second connecting unit forwarding at least a part of the received field data to at least one internet browser program over the second part of the communication network structure;
a non-statutory tangible storage medium including a control program comprising a browser executable application which, when executed by an internet browser program, receives and processes field data from field devices of a process automation system and generates and sends out control data to field devices of the system; and
a web server program for sending out the application to at least one requesting internet browser program.
